(19) United States
(12) Patent Application Publication
(10) Pub. No.: US 2026/0105275 A1
(43) Pub. Date: Apr. 16, 2026

(54) IMAGE PROCESSING APPARATUS AND CORRESPONDENCE ADJUSTMENT METHOD

(71) Applicant: SEIKO EPSON CORPORATION, Tokyo (JP)

(72) Inventors: Shota ITAGAKI, SHIOJIRI-SHI (JP); Takahiro KAMADA, MATSUMOTO-SHI (JP); Takuya ONO, SHIOJIRI-SHI (JP)

(21) Appl. No.: 19/358,945

(22) Filed: Oct. 15, 2025

(30) Foreign Application Priority Data
Oct. 16, 2024 (JP) 2024-180621

(51) Int. Cl. G06K 15/02

(52) U.S. Cl. CPC G06K 15/1878; G06K 15/1882; G06K 2215/0094; G06K 2215/101

(57) ABSTRACT

An image processing apparatus includes a storage unit configured to store a correspondence between input coordinate values in an input color space that depends on an input device and output coordinate values in an output color space that depends on an output device; and a processing unit configured to convert the input coordinate values into the output coordinate values in accordance with the correspondence. The processing unit is configured to perform first adjustment on the correspondence, the first adjustment identifying darkest point output coordinate values that are the output coordinate values of a darkest point in the output color space and associating the darkest point output coordinate values with darkest point input coordinate values that are the input coordinate values of an input darkest point that is a point where brightness is lowest in the input color space, and perform second adjustment on the correspondence, the second adjustment smoothing the output coordinate values corresponding to an adjustment point within an adjustment range around the input darkest point in the input color space based on the darkest point output coordinate values.

The present application is based on, and claims priority from JP Application Serial Number 2024-180621, filed October 16, 2024, the disclosure of which is hereby incorporated by reference herein in its entirety.

### BACKGROUND

### 1. Technical Field

The present disclosure relates to an image processing apparatus and a correspondence adjustment method.

### 2. Related Art

A profile such as an ICC (International Color Consortium) profile is used to express color characteristics of a device. The profile includes a source profile representing the correspondence between device-dependent colors and device-independent colors in the input color space, a destination profile representing the correspondence between device-dependent colors and device-independent colors in the output color space, and other profiles. For example, combining the source profile representing the color characteristics of a display device with the destination profile representing the color characteristics of a printing device allows determination of the coordinate values in the output color space that cause the printing device to reproduce the same color as the display device. The device-dependent colors are each expressed by coordinate values in a device-dependent color space. The device-independent colors are each expressed, for example, by a color value in the CIE (International Commission on Illumination) L^{*}a^{*}b^{*} color space or a color value in the CIE XYZ color space, which are each a device-independent color space. In the following description, "^{*}" will be omitted from L^{*}, a^{*}, and b^{*}.

JP-A-2013-005128 shows a device link profile, which is the combination of the source profile and the destination profile.

JP-A-2013-005128 is an example of the related art.

For example, when the darkest point (point where brightness is lowest) in the input color space is outside the color gamut of the output color space, the darkest point in the input color space is mapped onto a point in a color gamut of the output color space. The mapping destination in the output color space is, however, not the darkest point in the output color space. Even when black point correction is performed at the time of the mapping, the mapping destination in the output color space is not the darkest point in the output color space.

### SUMMARY

An image processing apparatus according to an aspect of the present disclosure includes

a storage unit configured to store a correspondence between input coordinate values in an input color space that depends on an input device and output coordinate values in an output color space that depends on an output device; and

a processing unit configured to convert the input coordinate values into the output coordinate values in accordance with the correspondence,

wherein the processing unit is configured to

perform first adjustment on the correspondence, the first adjustment identifying darkest point output coordinate values that are the output coordinate values of a darkest point in the output color space and associating the darkest point output coordinate values with darkest point input coordinate values that are the input coordinate values of an input darkest point that is a point where brightness is lowest in the input color space, and

perform second adjustment on the correspondence, the second adjustment smoothing the output coordinate values corresponding to an adjustment point within an adjustment range around the input darkest point in the input color space based on the darkest point output coordinate values.

A correspondence adjustment method according to an aspect of the present disclosure is a correspondence adjustment method for adjusting a correspondence used to convert input coordinate values in an input color space that depends on an input device into output coordinate values in an output color space that depends on an output device, the method including:

a first adjustment step of performing first adjustment on the correspondence, the first adjustment identifying darkest point output coordinate values that are the output coordinate values of a darkest point in the output color space and associating the darkest point output coordinate values with darkest point input coordinate values that are the input coordinate values of an input darkest point that is a point where brightness is lowest in the input color space, and

a second adjustment step of performing second adjustment on the correspondence, the second adjustment smoothing the output coordinate values corresponding to an adjustment point within an adjustment range around the input darkest point in the input color space based on the darkest point output coordinate values.

### BRIEF DESCRIPTION OF THE DRAWINGS

FIG. 1 diagrammatically shows an example of the configuration of a printing system.

FIG. 2 is a block diagram diagrammatically showing an example of the configuration of the printing system.

FIG. 3 is a block diagram diagrammatically showing an example of a process carried out by a profile converter incorporated in an image processing apparatus.

FIG. 4 diagrammatically shows an example of the structure of a profile.

FIG. 5 diagrammatically shows an example of color gamuts and darkest points of a device.

FIG. 6 is a flowchart diagrammatically showing an example of a print control process.

FIG. 7 diagrammatically shows an example of contents displayed on a user interface screen.

FIG. 8 diagrammatically shows an example of an adjustment range over which output coordinate values are smoothed.

FIG. 9 diagrammatically shows an example of adjustment of a device link profile.

FIG. 10 diagrammatically shows examples of input values, and output values before and after the adjustment.

FIG. 11 diagrammatically shows a variation of the user interface screen.

FIG. 12 is a flowchart diagrammatically showing a variation of the print control process.

### DESCRIPTION OF EMBODIMENTS

An embodiment of the present disclosure will be described below. The following embodiment, of course, merely shows an example of the present disclosure, and all the features shown in the embodiment are not necessarily essential to the solution disclosed herein.

### 1 Overview of aspects included in the present disclosure:

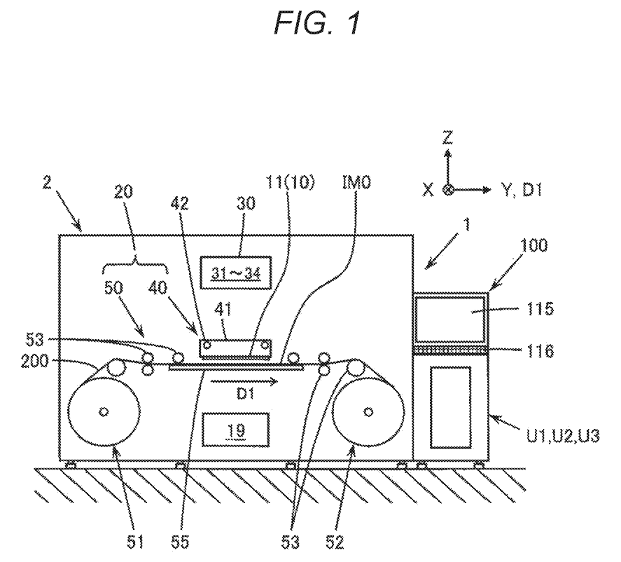

An overview of aspects included in the present disclosure will first be described with reference to examples shown in FIGS. 1 to 12. Note that the figures in the present application diagrammatically show examples, and that the magnification in each direction shown in the figures may vary, so that the figures may not be consistent in magnification. Each element in the aspects of the present disclosure is, of course, not limited to the specific example indicated by the reference character. In "Overview of aspects included in the present disclosure", a term in parentheses means a supplementary description of the term immediately before the parentheses.

In the present application, the numerical range "from Min to Max" means numerals greater than or equal to a minimum value Min but smaller than or equal to a maximum value Max.

### First aspect

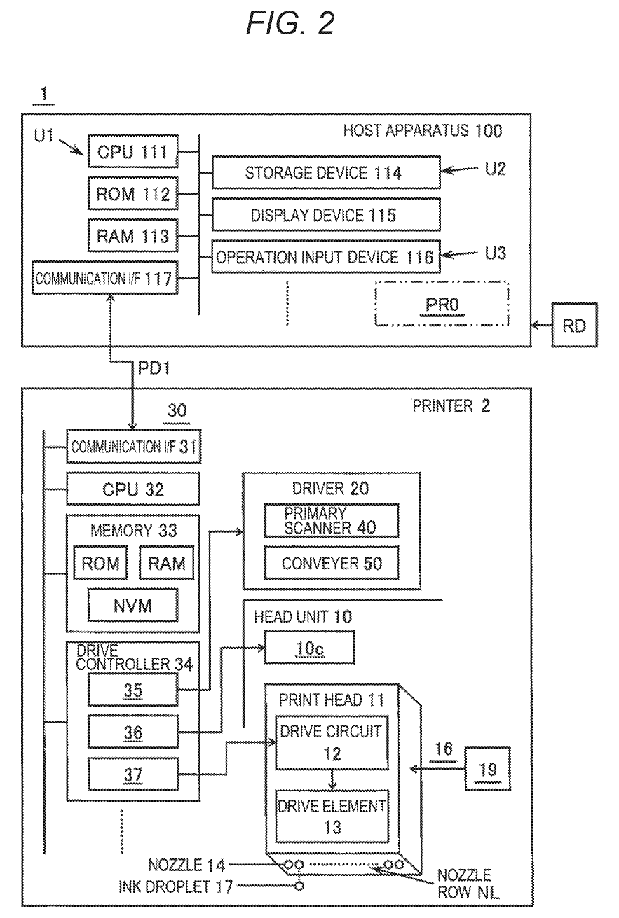

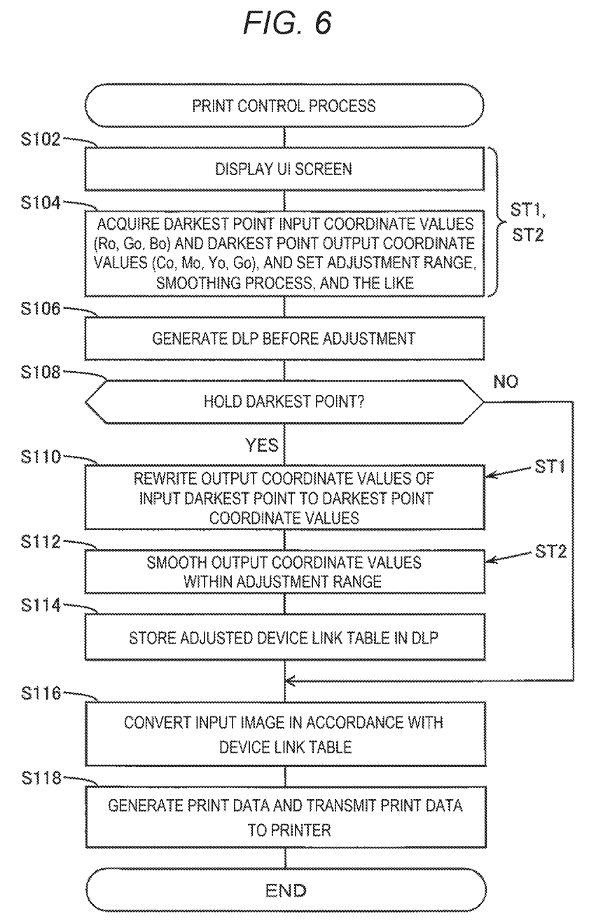

An image processing apparatus according to an aspect (host apparatus 100, for example) includes a storage unit U2 and a processing unit U1, as shown in FIGS. 1 and 2 by way of example. The storage unit U2 stores the correspondence (device link profile 330, for example) between input coordinate values (RGBin, for example) in an input color space CS1, which depends on an input device (display device 115, for example), and output coordinate values (CMYKout, for example) in an output color space CS2, which depends on an output device (printer 2, for example). The processing unit U1 converts the input coordinate values (RGBin) into the output coordinate values (CMYKout) in accordance with the correspondence (330) described above. The processing unit U1 performs first adjustment (steps S102 to S104, S110, for example) on the correspondence (330), the first adjustment identifying darkest point output coordinate values (Co, Mo, Yo, Ko, for example) that are the output coordinate values (CMYKout) of a darkest point (output darkest point DP2, for example) in the output color space CS2, and associating the darkest point output coordinate values (Co, Mo, Yo, Ko) with darkest point input coordinate values (Ro, Go, Bo, for example) that are the input coordinate values (RGBin) of an input darkest point DP1, which is a point where the brightness is lowest in the input color space CS1, as shown in FIG. 6 and other figures by way of example. The processing unit U1 further performs second adjustment (steps S102 to S104 and S112, for example) on the correspondence (330), the second adjustment smoothing the output coordinate values (CMYKout) corresponding to an adjustment point (grid point GD1, for example) within an adjustment range AR0 around the input darkest point DP1 in the input color space CS1 based on the darkest point output coordinate values (Co, Mo, Yo, Ko).

The darkest point in the input color space CS1 is thus converted into the darkest point in the output color space CS2, and the vicinity of the darkest point is smoothed in the input color space CS1. Therefore, according to the aspect described above, an image processing apparatus capable of maintaining continuous gradation in a dark portion while ensuring that black color output from the output device has the maximum density.

Various examples are listed in the aspect described above.

Examples of the input device may include a display device and a printing device. Examples of the input color space may include an RGB color space, a CMY color space, and a CMYK color space. Note that R means red, G means green, B means blue, C means cyan, M means magenta, Y means yellow, and K means black.

Examples of the output device may include a display device and a printing device. Examples of the output color space may include a CMYK color space, a CMY color space, and an RGB color space.

Examples of the correspondence between the input coordinate values and the output coordinate values may include a profile such as a device link profile, and a calculation formula. The profile means an information group including one or more lookup tables.

In the present application, "first", "second", and so on are terms used to identify each of multiple elements similar to each other, and do not mean the order of the elements.

The additional remarks described above, of course, also apply to the following aspects.

### Second aspect

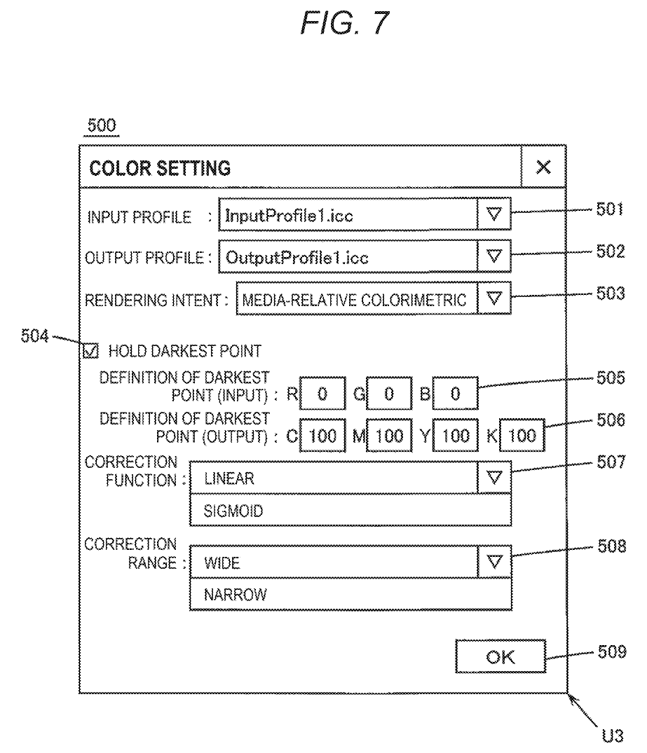

The image processing apparatus may further include an acceptance unit U3 configured to accept a setting of at least one of the darkest point input coordinate values (Ro, Go, Bo) and the darkest point output coordinate values (Co, Mo, Yo, Ko), as shown in FIG. 7 and other figures by way of example.

In the case described above, since a user can freely set the coordinate values of the darkest point, darkest point matching can be performed on site in accordance with the user's preference, so that the user's various needs can be met.

### Third aspect

The image processing apparatus may further include an acceptance unit U3 configured to accept a setting of the adjustment range AR0, as shown in FIG. 7 and other figures by way of example. The processing unit U1 may be configured to perform the second adjustment within the set adjustment range AR0.

In the case described above, since the user can set the adjustment range AR0 around the input darkest point DP1, dark portion matching can be performed on site in accordance with the user's preference, so that various media having different color development characteristics can be handled.

### Fourth aspect

The image processing apparatus may further include an acceptance unit U3 configured to accept a setting of a smoothing process of smoothing the output coordinate values (CMYKout) corresponding to the adjustment point (GD1), as shown in FIG. 7 and other figures by way of example. The processing unit U1 may be configured to carry out the set smoothing process on the output coordinate values (CMYKout) corresponding to the adjustment point (GD1) in the second adjustment.

In the case described above, since the user can determine the smoothing process of smoothing the output coordinate values (CMYKout) corresponding to the adjustment point (GD1), dark portion matching can be performed on site in accordance with the user's preference, so that the user's various needs can be met.

### Fifth aspect

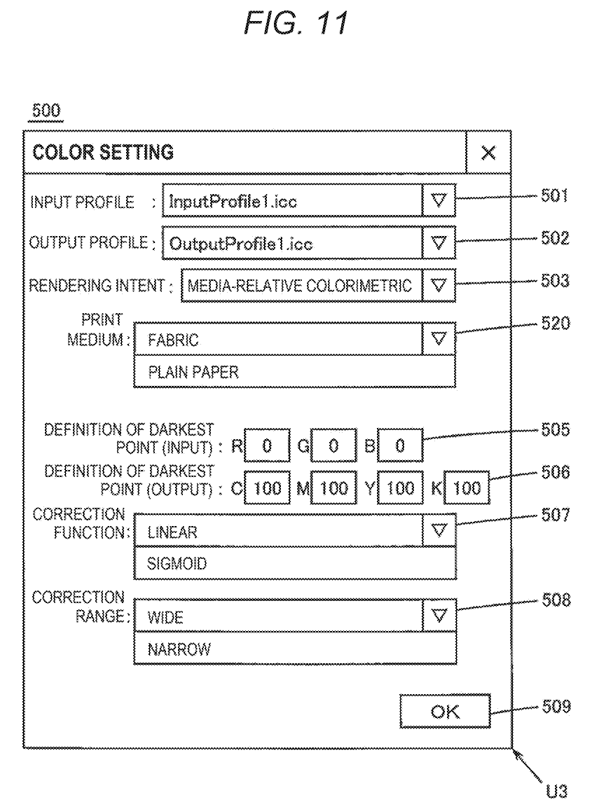

The output device may be a printer 2 configured to form a print image IM0 by discharging ink 16 onto a medium 200, an amount of the ink 16 corresponding to the output coordinate values (CMYKout). The image processing apparatus may further include an acceptance unit U3 configured to accept a setting of a type of the medium 200, on which the print image IM0 is formed, from multiple types including fabric and a second type different from the fabric, as shown in FIG. 11 by way of example. When the fabric is set as the type of the medium 200, on which the print image IM0 is formed, the processing unit U1 is configured to perform the first adjustment and the second adjustment on the correspondence (330), and convert the input coordinate values (RGBin) into the output coordinate values (CMYKout) in accordance with the correspondence (330) on which the first adjustment and the second adjustment are performed. When the second type is set as the type of the medium 200, on which the print image IM0 is formed, the processing unit U1 is configured to convert the input coordinate values (RGBin) into the output coordinate values (CMYKout) in accordance with the correspondence (330) on which the first adjustment and the second adjustment is not performed.

Fabric is likely to cause irregular reflection of light due to the unevenness at its surfaces, and fabric is further likely to allow ink to permeate thereinto, so that the color development of black is likely to decrease. In the aspect described above, since the color conversion in which the dark portion is adjusted is performed when the type of the medium 200, on which the print image IM0 is formed, is fabric, an image processing apparatus preferable for a printer can be provided.

### Sixth aspect

A correspondence adjustment method according to an aspect is a correspondence adjustment method for adjusting a correspondence (330) used to convert input coordinate values (RGBin) in an input color space CS1, which depends on an input device (115), into output coordinate values (CMYKout) in an output color space CS2, which depends on an output device (2), and includes the following steps:

(a1) A first adjustment step ST1 of performing first adjustment on the correspondence (330), the first adjustment identifying darkest point output coordinate values (Co, Mo, Yo, Ko), which are the output coordinate values (CMYKout) of a darkest point (DP2) in the output color space CS2 and associating the darkest point output coordinate values (Co, Mo, Yo, Ko) with darkest point input coordinate values (Ro, Go, Bo), which are the input coordinate values (RGBin) of an input darkest point DP1, which is a point where brightness is lowest, in the input color space CS1.

(a2) A second adjustment step ST2 of performing second adjustment on the correspondence (330), the second adjustment smoothing the output coordinate values (CMYKout) corresponding to an adjustment point (GD1) within an adjustment range AR0 around the input darkest point DP1 in the input color space CS1 based on the darkest point output coordinate values (Co, Mo, Yo, Ko).

According to the aspect described above, a correspondence adjustment method capable of maintaining continuous gradation in a dark portion while ensuring that black color output from the output device has the maximum density.

Furthermore, the aspect described above can be applied, for example, to an image processing system including the image processing apparatus described above, an image processing method, a correspondence determination program, an image processing program, and a computer-readable non-transitory medium on which any of the programs described above is recorded. The image processing apparatus may be configured with multiple discrete portions.

### 2 Specific example of printing system including image processing apparatus and output device:

FIGS. 1 and 2 diagrammatically show the configuration of a printing system 1 including the host apparatus 100 and the printer 2 by way of example. The host apparatus 100 incorporates the image processing apparatus. The printer 2 is an example of the output device.

The printer 2 shown in FIG. 1 is a fabric printer that forms the print image IM0 on fabric as the medium 200, and is a serial inkjet printer. The Y-axis direction shown in FIG. 1 indicates a feeding direction D1, in which the medium 200 is conveyed. The X-axis direction shown in FIG. 1 indicates a direction that intersects with the Y-axis direction, for example, a width direction of the medium 200 that is the direction perpendicular to the feeding direction D1. Each of the X-axis and Y-axis directions may be a horizontal direction as shown in FIG. 1, or may be a direction different from a horizontal direction. The Z-axis direction shown in FIG. 1 indicates a direction that intersects with the X-axis and Y-axis directions, for example, a vertical direction perpendicular to the X-axis and Y-axis directions.

The medium 200 shown in FIG. 1 is elongated fabric that is configured with a large number of fibers, has unevenness at the surfaces, and is supplied in the form of a roll of the wound fabric. The printer 2 shown in FIGS. 1 and 2 includes a driver 20, to which a head unit 10 is attached, a print controller 30, which controls the operation of the printer 2, and the like. The printer 2 having received print data PD1 from the host apparatus 100 causes the print controller 30 to control the head unit 10 and the driver 20 in accordance with the print data PD1 to form the print image IM0 on the medium 200.

The head unit 10 shown in FIG. 2 includes a print head 11, which is an inkjet head, and a head controller 10c, which controls the print head 11. The head unit 10 is mounted on a carriage 41, which is movable in a forward direction along the X-axis direction and a rearward direction opposite the forward direction, and accompanies the carriage 41 to make reciprocating motion. The driver 20 causes the carriage 41 to make reciprocating motion under the control of the print controller 30. Under the control of the print controller 30, the head unit 10 discharges ink droplets 17 from nozzles 14, which form a nozzle row NL, onto the medium 200 in a non-conveyed state on a platen 55 while moving in the forward or rearward direction to form a dot pattern formed by the ink droplets 17 on the medium 200.

The print head 11 can discharge C (cyan) ink, M (magenta) ink, Y (yellow) ink, and K (black) ink as the color ink 16. Note that the print head 11 may discharge ink having a color different from the four colors described above, for example, orange or green, or may discharge ink such as a treatment liquid that solidifies coloring materials of the color ink, for example, a treatment liquid that aggregates pigment.

The print head 11 has the nozzle row NL, in which the multiple nozzles 14 are arranged in a nozzle arrangement direction that intersects with the X-axis direction, and includes a drive circuit 12, drive elements 13, and the like. The multiple nozzles 14, which form the nozzle row NL, may be arranged in a staggered pattern. The nozzles 14 can each discharge color ink in the form of the ink droplets 17. The drive circuit 12 applies a voltage signal to each of the drive elements 13 in accordance with a drive signal input from the print controller 30. The drive elements 13 can, for example, each be a piezoelectric element that applies pressure to the ink 16 in a pressure chamber that communicates with the nozzles 14, or a drive element that discharges droplets, such as the ink droplets 17, from the nozzles 14 by generating bubbles in the pressure chamber with the aid of heat. The ink 16 is supplied to the pressure chamber of the print head 11 by an ink supplier 19 such as an ink tank or an ink cartridge. The ink 16 in the pressure chamber is discharged by the drive elements 13 in the form of droplets, such as the ink droplets 17, from the nozzles 14 toward the medium 200, so that the droplets form dots on the medium 200. The print image IM0 formed by multiple dots is formed on the medium 200.

The driver 20 includes a primary scanner 40, a conveyer 50, and the like, and moves the head unit 10 and the medium 200 relative to each other under the control of the print controller 30. The primary scanner 40 in the present specific example includes the carriage 41, a guide shaft 42, a carriage motor that is not shown, and the like, and causes the print head 11 to make reciprocating motion along the X-axis direction under the control of the print controller 30. The conveyer 50 in the present specific example includes a medium supplier 51, a medium storage 52, multiple conveyance rollers 53, the platen 55, and the like, and moves the medium 200 in the feeding direction D1 under the control of the print controller 30. The supplier 51 rotatably supports a reel around which the medium 200 is wound into a roll, and feeds the medium 200 to a conveyance path. The storage 52 rotatably supports a reel that winds the medium 200, and winds the medium 200 on which printing has been performed from the conveyance path. The multiple conveyance rollers 53 include a driving roller that moves the medium 200 in the feeding direction D1, a driven roller that rotates as the medium 200 moves, and other rollers. The medium 200 supplied from the supplier 51 to the conveyance path is conveyed via a printing region on the platen 55 and wound around the reel in the storage 52.

Note that when the printer 2 performs lateral printing, the carriage 41, on which the print head 11 is mounted, may move in the feeding direction D1 and a secondary scanning direction opposite the feeding direction D1.

The print controller 30 includes a communication interface (I/F) 31, a central processing unit (CPU) 32, which is a processor, a memory 33, a drive controller 34, and the like, and controls the operation of the printer 2. The communication I/F 31 is connected to a communication I/F 117 of the host apparatus 100. The communication I/Fs 31 and 117 perform bidirectional data communication. The memory 33 includes, for example, a read only memory (ROM) that is a semiconductor memory, a random access memory (RAM) that is a semiconductor memory, and a nonvolatile memory (NVM). Examples of the NVM may include a nonvolatile semiconductor memory such as a flash memory, and a magnetic storage device such as a hard disk. The CPU 32 controls the head unit 10 and the driver 20 via the drive controller 34 by executing a program stored in the memory 33.

Note that the print controller 30 may be configured with a system on a chip (SoC) or the like, and may include an application specific integrated circuit (ASIC).

The drive controller 34 includes a movement control signal generation circuit 35, a discharge control signal generation circuit 36, and a drive signal generation circuit 37, and controls the operations of the head unit 10 and the driver 20 under the control of the CPU 32. The movement control signal generation circuit 35 generates a movement control signal, which is used to control the primary scanner 40 and the conveyer 50, in accordance with an instruction from the CPU 32, and outputs the signal to the driver 20. The discharge control signal generation circuit 36 generates a head control signal, which is used to select a nozzle from which the ink 16 is discharged, select an amount of the ink 16 to be discharged, control the timing at which the ink 16 is discharged, and perform other operations in accordance with an instruction from the CPU 32, and outputs the signal to the head controller 10c of the head unit 10. The drive signal generation circuit 37 generates drive signals used to drive the drive elements 13 of the print head 11, and outputs the signals to the drive circuit 12. The drive controller 34 drives the drive elements 13 corresponding to the respective nozzles 14 based on the head control signal and the drive signals.

As described above, the print controller 30 controls the primary scan, in which the print head 11 is caused to discharge the ink droplets 17 while the carriage 41 is moved, and the secondary scan, in which the medium 200 is fed by a predetermined amount in the feeding direction D1 between the primary scan operations.

The host apparatus 100 shown in FIGS. 1 and 2 includes a CPU 111, a ROM 112, a RAM 113, a storage device 114, a display device 115, an operation input device 116, the communication I/F 117, and the like. The elements 111 to 117 and the like are electrically coupled to each other, and can therefore each input information from any of the other elements and output information to any of the other elements. In the present specific example, the host apparatus 100 including the CPU 111 is an example of the processing unit U1, the storage device 114 is an example of the storage unit U2, the display device 115 is an example of the input device, and the host apparatus 100 including the operation input device 116 is an example of the acceptance unit U3. The storage unit U2 may, for example, be the RAM 113, an external recording medium RD, or a combination of two or more of the storage device 114, the RAM 113, and the recording medium RD. Examples of the host apparatus 100 may include a computer such as a personal computer (including tablet terminal), and a mobile phone such as a smartphone. The host apparatus 100 may include the elements 111 to 117 and the like in a single enclosure, or may be configured with multiple apparatuses separate from each other but communicative with each other. The host apparatus 100 and the printer 2 may be present in a common enclosure.

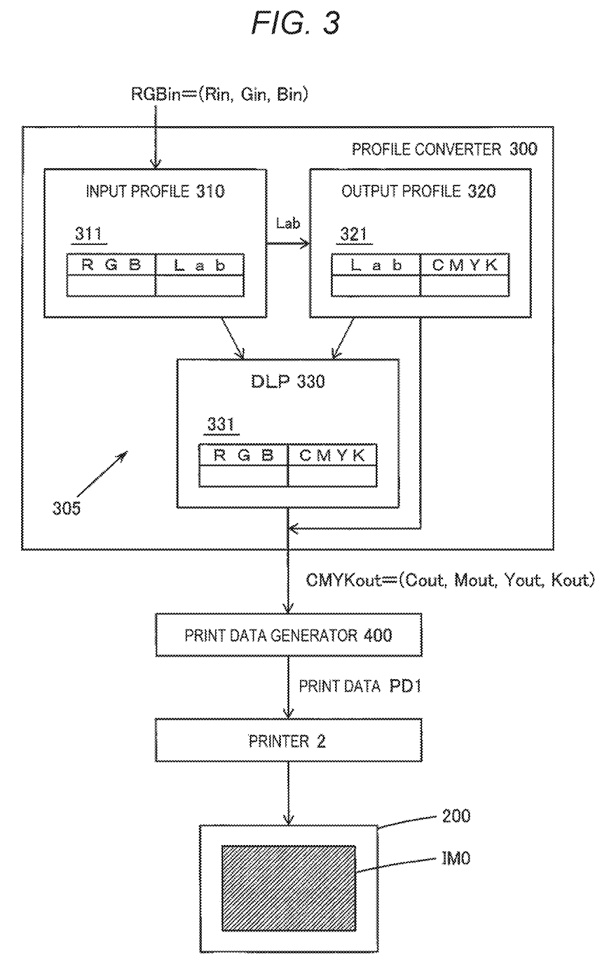

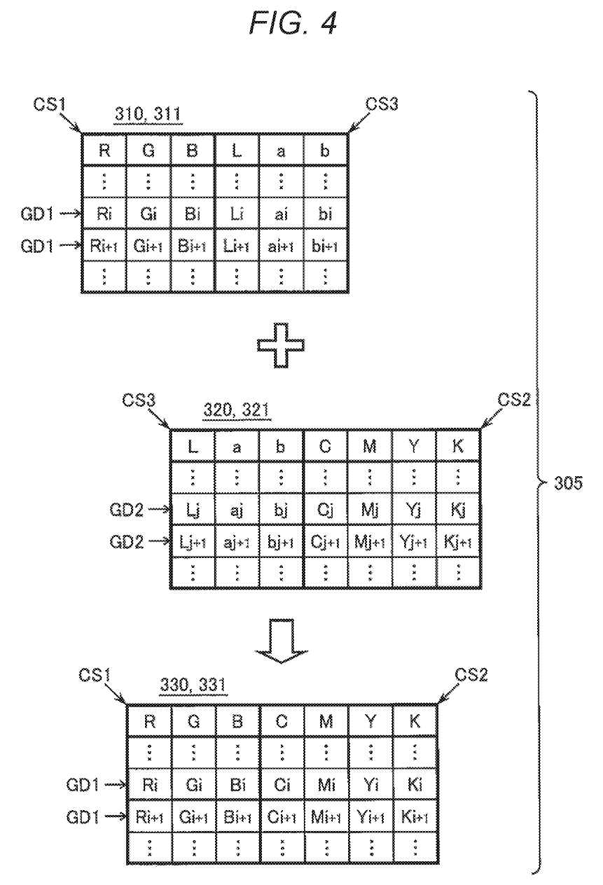

The storage device 114 stores an operating system, various driver programs including a print control program PR0, application programs, a profile 305 shown in FIGS. 3 and 4 by way of example, setting information, and the like. The print control program PR0 causes the host apparatus 100 to realize functions corresponding to a profile converter 300 and a print data generator 400 shown in FIG. 3 by way of example. The CPU 111 reads information stored in the storage device 114 as appropriate into the RAM 113 and executes the read programs to carry out various processes. The storage device 114 can be a nonvolatile semiconductor memory, a magnetic storage device, or the like. A computer-readable medium that stores the print control program PR0 is not limited to a storage device inside the host apparatus 100, and may be the recording medium RD outside the host apparatus 100. The display device 115 is a human interface that displays information, and can, for example, be a liquid crystal display panel. The operation input device 116 is a human interface to which information is input, and can, for example, be a pointing device, hardware keys including a keyboard, or a touch panel attached to the surface of a display panel.

FIG. 3 diagrammatically shows an example of a process carried out by the profile converter 300 incorporated in the image processing apparatus. FIG. 4 diagrammatically shows the structure of the profile 305 by way of example. The profile 305 collectively refers to an input profile 310 also called a source profile, an output profile 320 also called a destination profile, and a device link profile (DLP) 330.

The profile converter 300 is also referred to as a color management system, and is realized in the host apparatus 100, for example, by a raster image processor (RIP). The profile converter 300 converts input coordinate values in a color space that depends on the input device into output coordinate values in a color space that depends on the output device in accordance with the profile 305 such as the ICC profile. It is now assumed that the input device is the display device 115, the output device is the printer 2, the input color space CS1 is the RGB color space, and the output color space CS2 is the CMYK color space. FIG. 3 shows that the input coordinate values RGBin in the RGB color space have components (Rin, Gin, Bin), and that the output coordinate values CMYKout in the CMYK color space have components (Cout, Mout, Yout, Kout). The profile converter 300 generates an output image having the output coordinate values CMYKout on a pixel basis based on an input image having the input coordinate values RGBin on a pixel basis.

The profile converter 300 can convert the input coordinate values RGBin into Lab values by referring to an A2B table 311 contained in the input profile 310, and can convert the Lab values into the output coordinate values CMYKout by referring to a B2A table 321 contained in the output profile 320. The Lab values mean coordinate values in the CIE Lab color space. The profile converter 300 can generate the DLP 330 based on the input profile 310 and the output profile 320, and can convert the input coordinate values RGBin into the output coordinate values CMYKout by referring to a device link table 331 contained in the DLP 330.

When the profile converter 300 generates the output image from the input image, the print data generator 400 generates the print data PD1 used to form the print image IM0 based on the output image, and transmits the print data PD1 to the printer 2. For example, the print data generator 400 generates the print data PD1 by converting each of the output coordinate values CMYKout of the output image into gradation values corresponding to the amount of ink to be used and adding a print command to the resultant data on the amount of ink. In this case, when the printer 2 receives the print data PD1, the CPU 32, which plays a key role, generates dot data representing the state of dot formation based on the data on the amount of ink, controls the drive controller 34 based on the print command and the dot data, and operates the head unit 10 including the print head 11, and the driver 20 in accordance with the print data PD1. That is, the printer 2 forms the print image IM0 by discharging the ink 16 the amount of which corresponds to the output coordinate values CMYKout onto the medium 200.

As described above, the print image IM0 corresponding to the output image from the profile converter 300 is formed on the medium 200.

The A2B table 311 of the input profile 310 is data representing the correspondence between coordinate values (Rᵢ, Gᵢ, Bᵢ) in the input color space CS1, which depends on the input device, and coordinate values (Lᵢ, aᵢ, bᵢ) in a profile coupling space CS3, which is the Lab color space, as shown in FIG. 4. The variable i is a variable that identifies the grid point GD1 set in the input color space CS1. Coordinate values in the profile coupling space CS3 are hereinafter also referred to as PCS values. When the input color space CS1 is a three-dimensional RGB color space, the grid points GD1 in the A2B table 311 are typically arranged at substantially equal intervals in the R-axis direction, the G-axis direction, and the B-axis direction in the RGB color space. It can also be said that the A2B table 311 is a three-dimensional table used to convert the input coordinate values (Rᵢ, Gᵢ, Bᵢ) into the PCS values (Lᵢ, aᵢ, bᵢ). Although not shown, the input profile 310 also has a B2A table used to convert PCS values into RGB values.

The B2A table 321 of the output profile 320 is data representing the correspondence between the coordinate values (Lⱼ, aⱼ, bⱼ) in the profile coupling space CS3 and the coordinate values (Cⱼ, Mⱼ, Yⱼ, Kⱼ) in the output color space CS2, which depends on the output device. The variable j is a variable that identifies a grid point GD2 set in the profile coupling space CS3. The grid points GD2 in the B2A table 321 are typically arranged at substantially equal intervals in the L-axis direction, the a-axis direction, and the b-axis direction in the Lab color space. It can also be said that the B2A table 321 is a three-dimensional table used to convert the PCS values (Lⱼ, aⱼ, bⱼ) into the output coordinate values (Cⱼ, Mⱼ, Yⱼ, Kⱼ) Although not shown, the output profile 320 also has an A2B table used to convert CMYK values into PCS values.

The DLP 330 is generated by combining the input profile 310 and the output profile 320 with each other in accordance with a rendering intent. The device link table 331 of the DLP 330 is data representing the correspondence between the coordinate values (Rᵢ, Gᵢ, Bᵢ) in the input color space CS1 and the coordinate values (Cᵢ, Mᵢ, Yᵢ, Kᵢ) in the output color space CS2. It can also be said that the device link table 331 is a three-dimensional table used to convert the input coordinate values (Rᵢ, Gᵢ, Bᵢ) into the output coordinate values (Cᵢ, Mᵢ, Yᵢ, Kᵢ). It can be said that when the DLP 330 is stored in the storage device 114, the storage unit U2 stores the correspondence between the input coordinate values RGBin in the input color space CS1 and the output coordinate values CMYKout in the output color space CS2. In the present specific example, it can be said that the profile converter 300 is the processing unit U1 that converts the input coordinate values RGBin into the output coordinate values CMYKout in accordance with the DLP 330.

Each of the conversion tables contained in the profiles (310, 320, 330) is not limited to a single conversion table, and may be a combination of multiple conversion tables, such as the combination of a one-dimensional conversion table, a three-dimensional or four-dimensional conversion table, and a one-dimensional conversion table. Therefore, the conversion table shown in FIG. 4 may directly indicate a three-dimensional or four-dimensional conversion table contained in any of the profiles (310, 320, 330) or may indicate a state in which multiple conversion tables contained in any of the profiles (310, 320, 330) are combined with each other.

The grid points mean imaginary points disposed in an input-side color space, and it is assumed that output -side coordinate values corresponding to the positions of the grid points in the color space are stored at the grid points. The multiple grid points may be arranged evenly or unevenly in the color space.

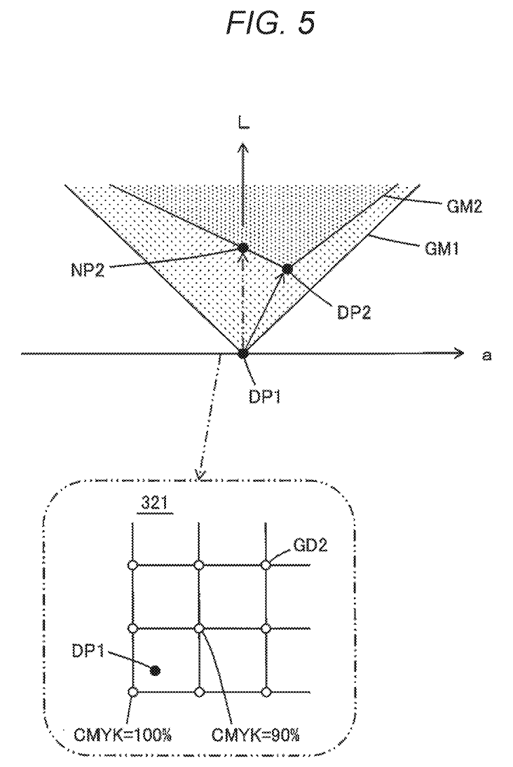

FIG. 5 diagrammatically shows color gamuts (GM1 and GM2) and the darkest points (DP1 and DP2) of a device by way of example.

In general, the color gamut GM2 of the output device differs from the color gamut GM1 of the input device, and the output darkest point DP2, which is the point where the brightness is lowest, in the output color space CS2 differs from the input darkest point DP1, which is the point where the brightness is lowest, in the input color space CS1. FIG. 5 shows that the color gamut GM2 of the output device is narrower than the color gamut GM1 of the input device in the dark portion, and that the input darkest point DP1 is outside the color gamut GM2 of the output device. In this case, the profile converter 300 maps the input darkest point DP1 onto a point in the color gamut GM2 of the output device in accordance with the input profile 310, the output profile 320, and the rendering intent. A mapping destination point NP2 is, however, not the output darkest point DP2. Even when black point correction is made at the time of the mapping, the mapping destination point NP2 does not become the output darkest point DP2. When the DLP 330 is generated from the input profile 310 and the output profile 320 in this state, the input darkest point DP1 is converted into the point NP2 brighter than the output darkest point DP2.

The reason why the mapping destination point NP2 does not become the output darkest point DP2 is believed to be that the output coordinate values of the point NP2 corresponding to the input darkest point DP1 are interpolated in accordance with the B2A table 321 of the output profile 320 at the time of the mapping, as shown in the two-dot-chain-line box in the lower part of FIG. 5. There may be no output coordinate values of the output darkest point DP2 in the B2A table 321 in the first place depending on how to create the output profile 320. As described above, the grid points GD2 in the B2A table 321 are discretely arranged in the L-axis direction, the a-axis direction, and the b-axis direction in the Lab color space as the profile coupling space CS3. When the Lab values corresponding to the input darkest points DP1 in the A2B table 311 of the input profile 310 do not coincide with those at any of the grid points GD2 in the B2A table 321, interpolation operation is performed on the output coordinate values corresponding to multiple grid points GD2. In this case, the point NP2 onto which the input darkest point DP1 is mapped is not the output darkest point DP2. Even when black point correction is made at the time of the mapping, the mapping destination point NP2 does not become the output darkest point DP2 unless the mapping destination point NP2 coincides with any of the grid points GD2 in the B2A table 321. For example, since the output coordinate values of the point NP2 corresponding to the input darkest point DP1 are interpolated, even when a grid point GD2 having CMYK values of (100%, 100%, 100%, 100%) of the output darkest point DP2 is referred to, but when a grid point GD2 having CMYK values of (90%, 90%, 90%, 90%) is referred to as shown in FIG. 5, the output coordinate values of the point NP2 do not have the CMYK value of (100%, 100%, 100%, 100%). In this case, the output coordinate values of the point NP2, that is, the C value, the M value, the Y value, and the K value are each greater than 90% but smaller than 100%.

Even when the color gamut GM2 of the output device is wider than the color gamut GM1 of the input device in the dark portion, the output coordinate values of the point NP2 corresponding to the input darkest point DP1 are interpolated in accordance with the B2A table 321 at the time of the mapping, so that the point NP2 does not become the output darkest point DP2.

Therefore, in the present specific example, the first adjustment, which associates the darkest point output coordinate values (Co, Mo, Yo, Ko), which are the output coordinate values CMYKout of the output darkest point DP2, with the darkest point input coordinate values (Ro, Go, Bo), which are the input coordinate values RGBin of the input darkest point DP1, is made on the DLP 330, as shown in FIG. 6 and the following figures by way of example. Only the first adjustment may, however, cause failure of the gradation of the output image, such as a situation in which the detail of the gradation of the output image is lost and turned into black. Therefore, in the present specific example, the second adjustment, which smooths the output coordinate values CMYKout corresponding to the grid points GD1 within the adjustment range AR0 around the input darkest point DP1 in the input color space CS1 based on the darkest point output coordinate values (Co, Mo, Yo, Ko), is made on the DLP 330.

### 3 Specific example of processes carried out by printing system including image processing apparatus:

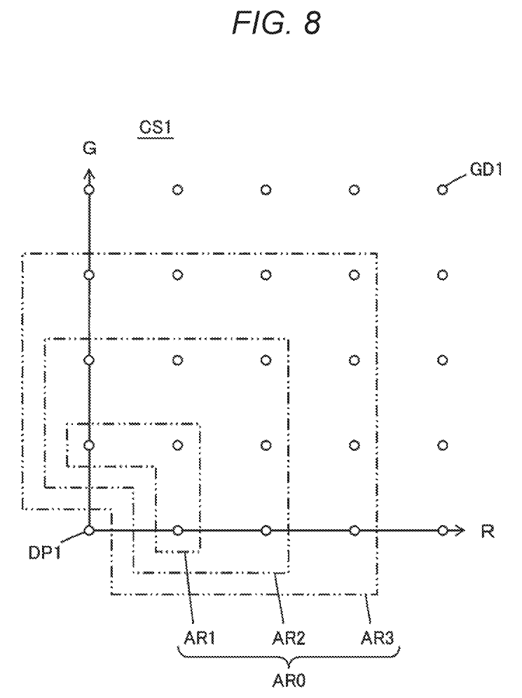

FIG. 6 diagrammatically shows a print control process carried out by the host apparatus 100 including the image processing apparatus by way of example. FIG. 7 diagrammatically shows a user interface screen (UI) 500 displayed on the display device 115 in step S102 by way of example. FIG. 8 diagrammatically shows the adjustment range AR0, over which the output coordinate values CMYKout are smoothed, by way of example.

Upon acceptance of an instruction of printing an image corresponding to the input image on the medium 200, the host apparatus 100 starts the print control process shown in FIG. 6. Steps S102 to S104 and S110 correspond to the first adjustment step ST1, and steps S102 to S104 and S112 correspond to the second adjustment step ST2. The profile converter 300 shown in FIG. 3 carries out the processes in steps S102 to S116, and the print data generator 400 shown in FIG. 3 carries out the process in step S118. Hereinafter, the description of "step" may be omitted, and the reference characters of the steps may be shown in parentheses.

When the print control process starts, the host apparatus 100 displays the UI screen 500 shown in FIG. 7 on the display device 115 (S102). The UI screen 500 has an input profile selection field 501, an output profile selection field 502, a rendering intent selection field 503, a darkest point holding checkbox 504, a darkest point input coordinate value input field 505, a darkest point output coordinate value input field 506, a smoothing process selection field 507, an adjustment range selection field 508, an OK button 509, and the like. Note that on the UI screen 500, a "correction function" is displayed as the smoothing process, and a "correction range" is displayed as the adjustment range AR0.

The host apparatus 100 accepts an operation performed on the input profile selection field 501 via the operation input device 116 to accept selection of the input profile 310 from profiles stored in the storage device 114. The host apparatus 100 accepts an operation performed on the output profile selection field 502 via the operation input device 116 to accept selection of the output profile 320 from profiles stored in the storage device 114. The host apparatus 100 accepts an operation performed on the rendering intent selection field 503 via the operation input device 116 to accept selection of a rendering intent to be applied from multiple rendering intents. The multiple rendering intents include, for example, "perceptual", "media-relative colorimetric", "absolute colorimetric", and "saturation".

The host apparatus 100 accepts an operation performed on the darkest point holding checkbox 504 via the operation input device 116 to accept selection of whether or not to hold the darkest point. When the darkest point holding checkbox 504 is checked, the darkest point is held, and when the darkest point holding checkbox 504 is not checked, the darkest point is not held. When the darkest point holding checkbox 504 is not checked, the host apparatus 100 may not accept operations to be performed on the fields described below (505 to 508).

The host apparatus 100 displays default darkest point input coordinate values (Ro, Go, Bo) in the darkest point input coordinate value input field 505, and accepts an operation performed on the darkest point input coordinate value input field 505 via the operation input device 116. FIG. 7 shows that default darkest point input coordinate values (Ro, Go, Bo) = (0%, 0%, 0%) are displayed in the darkest point input coordinate value input field 505. The user can use the operation input device 116 to perform an operation of changing the darkest point input coordinate values (Ro, Go, Bo) in the darkest point input coordinate value input field 505. The host apparatus 100 further displays default darkest point output coordinate values (Co, Mo, Yo, Ko) in the darkest point output coordinate value input field 506, and accepts an operation performed on the darkest point output coordinate value input field 506 via the operation input device 116. FIG. 7 shows that default darkest point output coordinate values (Co, Mo, Yo, Ko) = (100%, 100%, 100%, 100%) are displayed in the darkest point output coordinate value input field 506. The user can use the operation input device 116 to perform an operation of changing the darkest point output coordinate values (Co, Mo, Yo, Ko) in the darkest point output coordinate value input field 506. For example, when the amount of ink that can be discharged onto the medium 200 per unit area is limited, the darkest point output coordinate values (Co, Mo, Yo, Ko) may be changed to (50%, 50%, 50%, 100%), (0%, 0%, 0%, 100%), or the like. As described above, the present specific example is also effective for a medium onto which only a small amount of ink can be discharged per unit area.

The host apparatus 100 accepts an operation performed on the smoothing process selection field 507 via the operation input device 116 to accept selection of a smoothing process to be applied from multiple smoothing processes. The multiple smoothing processes include, for example, "linear" for linear correction, "sigmoid" for S-shaped correction, and "spline function" for correction using spline interpolation. As described above, the present specific example, in which the user can change the smoothing process, allows handling various media having different color development characteristics.

The host apparatus 100 accepts an operation performed on the adjustment range selection field 508 via the operation input device 116 to accept selection of an adjustment range to be applied from multiple adjustment ranges. The multiple adjustment ranges include, for example, "wide", "medium", and "narrow". As described above, the present specific example, in which the user can change the adjustment range, allows handling various media having different color development characteristics. FIG. 8 diagrammatically shows the input color space CS1 as a two-dimensional plane having the R-axis and the G-axis. The actual input color space CS1 is a three-dimensional space having the R-axis, the G-axis, and the B axis. The adjustment range AR0 shown in FIG. 8 includes an adjustment range AR1 corresponding to "narrow", an adjustment range AR2 corresponding to "medium", and an adjustment range AR3 corresponding to "wide". The adjustment ranges AR1, AR2, and AR3 are all adjacent to the input darkest point DP1. The adjustment range AR1 shown in FIG. 8 is a range that is around the input darkest point DP1 in the input color space CS1 and is separate from the input darkest point DP1 by one grid point interval. In this case, the number of the grid points GD1 that fall within the "narrow" adjustment range AR1 is 2³ − 1 = 7. The adjustment range AR2 shown in FIG. 8 is a range that is around the input darkest point DP1 in the input color space CS1 and is separate from the input darkest point DP1 by two grid point intervals. In this case, the number of the grid points GD1 that fall within the "medium" adjustment range AR2 is 3³ − 1 = 26. The "medium" adjustment range AR2 contains the "narrow" adjustment range AR1. The adjustment range AR3 shown in FIG. 8 is a range that is around the input darkest point DP1 in the input color space CS1 and is separate from the input darkest point DP1 by three grid point intervals. In this case, the number of the grid points GD1 that fall within the "wide" adjustment range AR3 is 4³ − 1 = 63. The "wide" adjustment range AR3 contains the "medium" adjustment range AR2. The grid points GD1 contained in the adjustment range AR1 correspond to the adjustment points.

Note that the adjustment range AR0 can be changed as appropriate. For example, the "wide" adjustment range AR3 may be a six-grid-point-interval range, the "medium" adjustment range AR2 may be a four-grid-point-interval range, and the "narrow" adjustment range AR1 may be a two-grid-point-interval range. The adjustment range AR0 may not contain the "medium" adjustment range AR2, and the multiple adjustment ranges may be two types of adjustment ranges, "wide" and "narrow".

When the operation input device 116 accepts an operation performed on the OK button 509, the host apparatus 100 carries out a process corresponding to the content displayed in each of the regions (501 to 508) (S104 in FIG. 6). The host apparatus 100 sets an input profile 310 to be used in accordance with the content displayed in the input profile selection field 501, and sets an output profile 320 to be used in accordance with the content displayed in the output profile selection field 502. The host apparatus 100 sets a rendering intent to be applied in accordance with the content displayed in the rendering intent selection field 503. The host apparatus 100 sets the darkest point to be held when the darkest point holding checkbox 504 is checked, and sets the darkest point not to be held when the darkest point holding checkbox 504 is not checked. The host apparatus 100 acquires the darkest point input coordinate values (Ro, Go, Bo) corresponding to the content displayed in the darkest point input coordinate value input field 505, and acquires the darkest point output coordinate values (Co, Mo, Yo, Ko) corresponding to the content displayed in the darkest point output coordinate value input field 506. It can be said that the host apparatus 100 including the operation input device 116 corresponds to the acceptance unit U3 that accepts the settings of the darkest point input coordinate values and the darkest point output coordinate values. The host apparatus 100 sets a smoothing process to be applied in accordance with the content displayed in the smoothing process selection field 507. It can be said that the host apparatus 100 including the operation input device 116 corresponds to the acceptance unit U3 that accepts the setting of a smoothing process of smoothing the output coordinate values CMYKout corresponding to the grid points GD1. The host apparatus 100 sets an adjustment range to be applied in accordance with the content displayed in the adjustment range selection field 508. It can be said that the host apparatus 100 including the operation input device 116 corresponds to the acceptance unit U3 that accepts the setting of the adjustment range AR0.

It can be said that the process of acquiring the darkest point output coordinate values (Co, Mo, Yo, Ko) in S102 to S104 is the process of identifying the darkest point output coordinate values.

After the process in S104, the host apparatus 100 generates the DLP 330 before the adjustment based on the input profile 310 and the output profile 320 in accordance with the rendering intent (S106). The DLP 330 can be generated, for example, as follows:

The host apparatus 100 first converts the PCS values (Lᵢ, aᵢ, bᵢ) at each of the grid points GD1 in the A2B table 311 of the input profile 310 in accordance with the B2A table 321 of the output profile 320. At this point in time, the PCS values (Lᵢ, aᵢ, bᵢ) are changed in accordance with the rendering intent as necessary. When the PCS values Lᵢ, aᵢ, bᵢ do not coincide with input values in the B2A table 321, the output coordinate values (Cᵢ, Mᵢ, Yᵢ, Kᵢ) in the device link table 331 are determined by performing an interpolation operation using the output coordinate values (Cⱼ, Mⱼ, Yⱼ, Kⱼ) of multiple grid points adjacent to the input values out of all the grid points GD2 in the B2A table 321. The host apparatus 100 then generates the device link table 331 by associating the input coordinate values (Rᵢ, Gᵢ, Bᵢ) with the output coordinate values (Cᵢ, Mᵢ, Yᵢ, Kᵢ) for each of the grid points GD1. The host apparatus 100 can generate the DLP 330 by storing the generated device link table 331 in the DLP 330.

As described above, the point NP2, onto which the input darkest point DP1 is mapped, is not the output darkest point DP2 because the interpolation operation is performed. S106 therefore shows "DLP before adjustment".

After generating the DLP 330 before the adjustment, the host apparatus 100 causes the procedure of the flowchart to branch off in accordance with whether to hold the darkest point (S108). When the darkest point holding checkbox 504 shown in FIG. 7 is checked, the host apparatus 100 carries out a darkest point holding process in S110 to S114. When the darkest point holding checkbox 504 shown in FIG. 7 is not checked, the host apparatus 100 does not carry out the darkest point holding process but proceeds to the process in S116.

The darkest point holding process in S110 to S114 will be described below.

The host apparatus 100 first rewrites the output coordinate values corresponding to the darkest point input coordinate values (Ro, Go, Bo) to the acquired darkest point output coordinate values (Co, Mo, Yo, Ko) in the device link table 331 (S110). The first adjustment step ST1 of performing the first adjustment, which associates the darkest point output coordinate values (Co, Mo, Yo, Ko) with the darkest point input coordinate values (Ro, Go, Bo), on the DLP 330 is executed by the processes in S102 to S104 and the darkest point association process in S110.

After the process in S110, the host apparatus 100 carries out the set smoothing process to smooth the output coordinate values CMYKout corresponding to the grid points GD1 within the adjustment range AR0 having been set in the device link table 331 based on the darkest point output coordinate values (Co, Mo, Yo, Ko) (S112). The second adjustment step ST2 of performing the second adjustment, which smooths the output coordinate values corresponding to the grid points GD1 within the set adjustment range AR0 based on the darkest point output coordinate values, on the DLP 330 is executed by the processes in S102 to S104 and the smoothing process in S112.

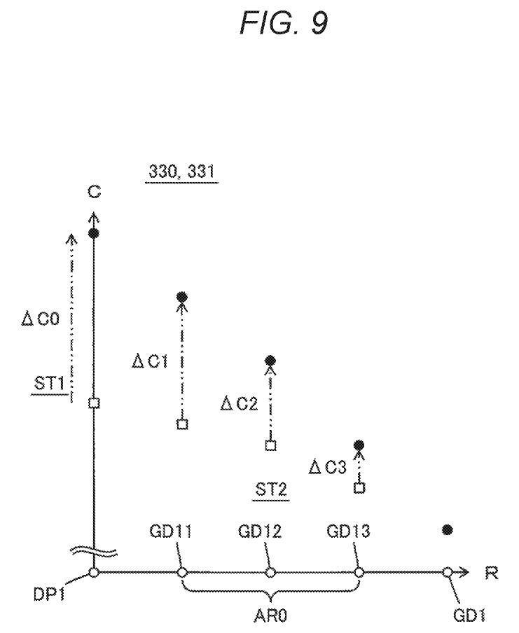

FIG. 9 diagrammatically shows the adjustment of the DLP 330 in the processes in S110 to S112 by way of example. To readily understand the adjustment, the horizontal axis of FIG. 9 diagrammatically represents the input color space CS1 in the form of a one-dimensional R-axis, with the grid points GD1 shown on the R-axis, and the vertical axis of FIG. 9 diagrammatically represents the output color space CS2 in the form of a one-dimensional C-axis. In other words, the horizontal axis represents the R-axis input coordinate values, and the vertical axis represents the C-axis output coordinate values. The actual input color space CS1 is a three-dimensional space having the R-axis, the G-axis, and the B-axis, and the actual output color space CS2 is a four-dimensional space having the C-axis, the M-axis, the Y-axis, and the K-axis. In FIG. 9, the open square marks indicate the C-axis output coordinate values associated with the grid points GD1 before the adjustment, and the filled circle marks indicate the C-axis output coordinate values associated with the grid points GD1 after the adjustment.

In the processes in S102 to S104 and the darkest point association process in S110, it is assumed that the first adjustment step ST1 of adding an amount of adjustment ΔC0 (ΔC0 > 0) to the C-axis output coordinate values associated with the input darkest points DP1 is executed. In the processes in S102 to S104 and the smoothing process in S112, the second adjustment step ST2 of adding amounts of adjustment ΔC1, ΔC2, and ΔC3 according to the set smoothing process to the C-axis output coordinate values associated with the grid points GD1 within the adjustment range AR0 is executed. FIG. 9 shows that the amount of adjustment of the output coordinate values of a grid point GD11 adjacent to the input darkest point DP1 is ΔC1, the amount of adjustment of the output coordinate values of a grid point GD12 adjacent to the grid point GD11 is ΔC2, and the amount of adjustment of the output coordinate values of a grid point GD13 adjacent to the grid point GD12 is ΔC3.In the smoothing process, ΔC0 > ΔC1 > ΔC2 > ΔC3 > 0 is typically satisfied. When the amounts of adjustment change linearly, the output coordinate values are adjusted, for example, as follows: ΔC1 = (3/4)ΔC0; ΔC2 = (2/4)ΔC0; and ΔC3 = (1/4)ΔC0. Although not shown, the M-axis, Y-axis, and K-axis output coordinate values are adjusted in the same manner.

As described above, the output coordinate values CMYKout corresponding to the grid points GD1 within the adjustment range AR0 are smoothed based on the darkest point output coordinate values (Co, Mo, Yo, Ko).

After the process in S112, the host apparatus 100 stores the device link table 331 having the adjusted output coordinate values CMYKout in the DLP 330 (S114).

The DLP 330 is thus adjusted.

In S116, the host apparatus 100 converts the input image having the input coordinate values RGBin on a pixel basis in accordance with the device link table 331 having undergone the darkest point holding process or the device link table 331 not having undergone the darkest point holding process. An output image having the output coordinate values CMYKout on a pixel basis is thus generated.

Finally, the host apparatus 100 generates the print data PD1 used to form the print image IM0 based on the output image, transmits the print data PD1 to the printer 2 (S118), and terminates the print control process. Upon reception of the print data PD1, the printer 2 forms the print image IM0 on the medium 200 in accordance with the print data PD1.

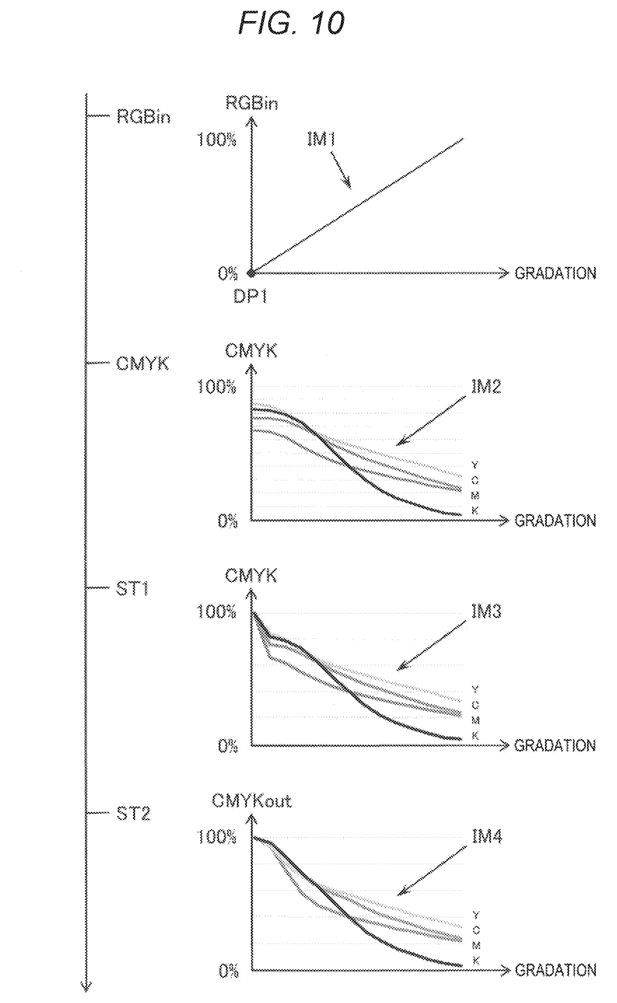

FIG. 10 diagrammatically shows examples of the input values, and the output values before and after the adjustment. It is assumed that the darkest point input coordinate values (Ro, Go, Bo) are (0%, 0%, 0%), and that the darkest point output coordinate values (Co, Mo, Yo, Ko) are (100%, 100%, 100%, 100%).

In FIG. 10, an input image IM1 is a gradation image in which the components (Rin, Gin, Bin) of the coordinate values RGBin in the RGB color space each change from 0% to 100% with Rin = Gin = Bin satisfied. A converted image IM2 is a CMYK image as a result of conversion of the input image IM1 in accordance with the DLP 330 before the adjustment. The output coordinate values CMYKout = (Cout, Mout, Yout, Kout) of the point NP2 corresponding to the input darkest point DP1 in the converted image IM2 are Cout < 100%, Mout < 100%, Mout < 100%, and Kout < 100%. The point NP2 corresponding to the input darkest point DP1 is therefore not the darkest point.

A converted image IM3 is a CMYK image having undergone the first adjustment step ST1 of replacing the output coordinate values of the point NP2 corresponding to the input darkest point DP1 with the darkest point output coordinate values (Co, Mo, Yo, Ko) but not having undergone the second adjustment step ST2. In the converted image IM3, the darkest point output coordinate values (Co, Mo, Yo, Ko) = (100%, 100%, 100%, 100%) are associated with the input darkest point DP1. In the converted image IM3, however, the gradation rapidly changes in the vicinity of the darkest point, and the continuous gradation in the dark portion is not maintained.

An output image IM4 is a CMYK image having undergone, in addition to the first adjustment step ST1, the second adjustment step ST2 of smoothing the output coordinate values CMYKout corresponding to the grid point GD1 within the adjustment range AR0 near the input darkest point DP1 based on the darkest point output coordinate values (Co, Mo, Yo, Ko). In the output image IM4, the darkest point output coordinate values (Co, Mo, Yo, Ko) = (100%, 100%, 100%, 100%) are associated with the input darkest point DP1, and the continuous gradation in the dark portion is maintained.

As described above, carrying out the darkest point holding process in S110 to S114 shown in FIG. 6 causes the input darkest point DP1 to be converted into the output darkest point DP2, so that the vicinity of the input darkest point DP1 in the input color space CS1 is smoothed. The image processing apparatus incorporated in the printing system 1 and the correspondence adjustment method performed in the darkest point holding process therefore allow the continuous gradation in the dark portion to be maintained while ensuring that black color output from the output device has the maximum density. The effect described above can be achieved by changing a module corresponding to the profile converter 300, and can therefore be extended to any model of the printer.

As the medium 200, fabric is likely to cause irregular reflection of light due to the unevenness of the fibers at its surfaces, and ink is likely to permeate between the fibers, that is into the fabric, so that the color development of black is likely to decrease. The image processing apparatus and the correspondence adjustment method described above are therefore particularly useful for maintaining the continuous gradation in a dark portion while ensuring that black output from a fabric printer has the maximum density.

Note that when the UI screen 500 shown in FIG. 7 is not provided with the darkest point input coordinate value input field 505 and the darkest point output coordinate value input field 506, it is difficult for the user to find which coordinate value in the device link table 331 should be adjusted. Providing the UI screen 500 with the darkest point input coordinate value input field 505 and the darkest point output coordinate value input field 506 allows the user to readily associate the output darkest point DP2 with the input darkest point DP1. Since the user can readily make adjustment that holds the darkest point, the image processing apparatus and the correspondence adjustment method described above are easy to use.

### 4 Variations:

Various variations of the present disclosure are conceivable.

For example, the printer 2 may be a line inkjet printer or the like including a print head having a nozzle row across the entire width of the medium 200.

A portion that plays a key role to carry out the processes described above is not limited to a CPU, and may be an electronic part other than a CPU, such as an application specific integrated circuit (ASIC). Multiple CPUs may, of course, cooperate with each other to carry out the processes described above, or a CPU and another electronic part (ASIC, for example) may cooperate with each other to carry out the processes described above.

The processes described above can be changed as appropriate, for example, the order of the processes may be changed. For example, in the print control process in FIG. 6, since the process in S104, such as the process of acquiring the darkest point output coordinate values, is carried out, the darkest point association process in S110 and the smoothing process in S112 can be swapped.

In the UI screen 500 shown in FIG. 7, the host apparatus 100 may not accept an operation performed on the darkest point input coordinate value input field 505 but may set the darkest point input coordinate values (Ro, Go, Bo) as default values. In this case, the host apparatus 100 accepts an operation performed on the darkest point output coordinate value input field 506 to realize the acceptance unit U3 that accepts the setting of the darkest point output coordinate values (Co, Mo, Yo, Ko). The host apparatus 100 may further set, for example, CMYK values that cause the L value to be minimized as the darkest point output coordinate values (Co, Mo, Yo, Ko) based on the A2B table of the output profile 320.

In the UI screen 500 shown in FIG. 7, the host apparatus 100 may not accept an operation performed on the darkest point output coordinate value input field 506 but may set the darkest point output coordinate values (Co, Mo, Yo, Ko) as default values. In this case, the host apparatus 100 accepts an operation performed on the darkest point input coordinate value input field 505 to realize the acceptance unit U3 that accepts the setting of the darkest point input coordinate values (Ro, Go, Bo). The host apparatus 100 may further set, for example, RGB values that cause the L value to be minimized as the darkest point input coordinate values (Ro, Go, Bo) based on the A2B table 311 of the input profile 310.

The medium 200 is not limited to an elongate medium and may be a cut medium. Furthermore, the medium 200 is not limited to fabric, and may be paper such as plain paper, glossy paper, or embossed paper.

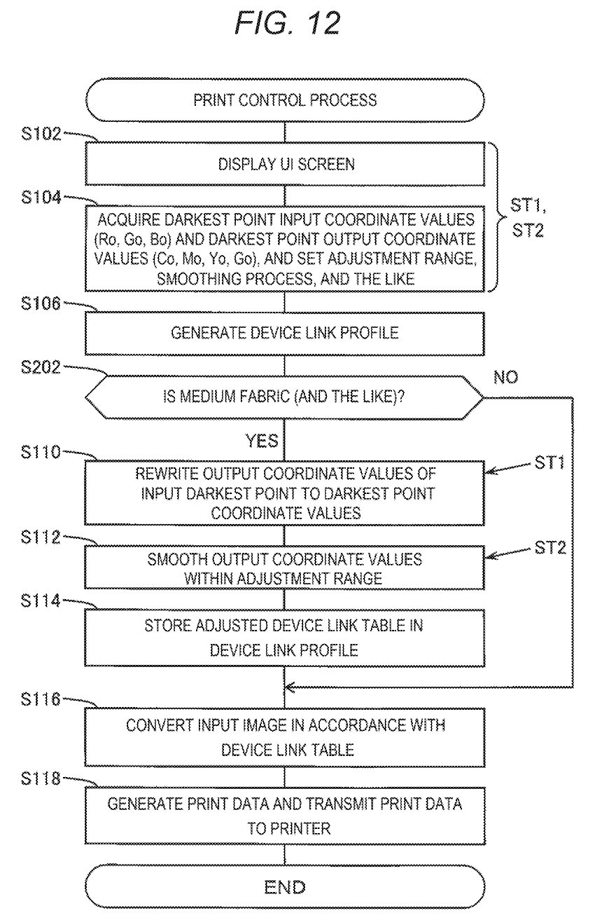

FIG. 11 diagrammatically shows a variation of the UI screen 500. FIG. 12 diagrammatically shows a variation of the print control process. It is assumed now that the printer 2 shown in FIGS. 1 and 2 can select the type of the medium 200, on which the print image IM0 is formed, from multiple types including fabric as a first type and a second type different from fabric.

The UI screen 500 shown in FIG. 11 differs from the UI screen 500 shown in FIG. 7 in that the darkest point holding checkbox 504 is replaced with a medium type selection field 520. Elements (501 to 503 and 505 to 509) shown in FIG. 11 are the same as the elements (501 to 503 and 505 to 509) shown in FIG. 7, and will therefore not be described in detail. The print control process shown in FIG. 12 differs from the print control shown in FIG. 6 in that the determination process in S108 is replaced with the determination process in S202. Since the processes in S102 to S106 and S110 to S118 shown in FIG. 12 are the same as the processes in S102 to S106 and S110 to S118 shown in FIG. 6, and will therefore not be described in detail.

When the print control process shown in FIG. 12 starts, the host apparatus 100 displays the UI screen 500 shown in FIG. 11 on the display device 115 (S102). The host apparatus 100 accepts an operation performed on the medium type selection field 520 via the operation input device 116 to accept selection of the type of the medium 200, on which the print image IM0 is formed, from usable types of the medium 200. In FIG. 11, fabric and plain paper are shown as the types of the medium 200. In this case, the plain paper is an example of the second type. The type of the medium 200 may, of course, include a type different from fabric and plain paper, such as glossy paper and embossed paper. When the host apparatus 100 accepts an operation performed on the OK button 509 via the operation input device 116, the host apparatus 100 carries out, for example, the process of setting the type of the medium 200 to be used in accordance with the content displayed in the medium type selection field 520 (S104). It can be said that the host apparatus 100 including the operation input device 116 corresponds to the acceptance unit U3 that accepts the setting of the type of the medium 200, on which the print image IM0 is formed, from multiple types including fabric and the second type different from fabric.

After the DLP is generated in S106, the host apparatus 100 causes the procedure of the flowchart to branch off in accordance with the set type of the medium 200 (S202). When fabric is set as the type of the medium 200, on which the print image IM0 is formed, the host apparatus 100 carries out the darkest point holding process in S110 to S114. When plain paper is set as the type of the medium 200, on which the print image IM0 is formed, the host apparatus 100 proceeds to the process in S116 without carrying out the darkest point holding process. Note that when the set type of the medium 200 differs from fabric and plain paper, the type may be treated as the first type, to which fabric belongs, or may be treated as the second type, to which plain paper belongs. For example, assuming that embossed paper belongs to the first type, the host apparatus 100 carries out the darkest point holding process in S110 to S114 when the first type such as fabric is set as the type of the medium 200, on which the print image IM0 is formed. Assuming that glossy paper belongs to the second type, the host apparatus 100 proceeds to the process in S116 without carrying out the darkest point holding process when the second type including plain paper and glossy paper is set as the type of the medium 200, on which the print image IM0 is formed.

In S116, the host apparatus 100 converts the input image into the output image in accordance with the device link table 331 having undergone the darkest point holding process or the device link table 331 not having undergone the darkest point holding process.

As described above, when fabric is set as the type of the medium 200, on which the print image IM0 is formed, the host apparatus 100 performs the first adjustment and the second adjustment on the DLP 330, and converts the input coordinate values RGBin into the output coordinate values CMYKout in accordance with the DLP 330 on which the first adjustment and the second adjustment have been performed. When the second type is set as the type of the medium 200, on which the print image IM0 is formed, the host apparatus 100 converts the input coordinate values RGBin into the output coordinate values CMYKout in accordance with the DLP 330 on which the first adjustment or the second adjustment has not been performed.

Finally, the host apparatus 100 transmits the print data PD1 generated based on the output image to the printer 2 (S118). The printer 2 forms the print image IM0 on the medium 200 in accordance with the received print data PD1.

As the medium 200, fabric is likely to cause irregular reflection of light due to the unevenness of the fibers at its surfaces, and ink is likely to permeate between the fibers, that is into the fabric, so that the color development of black is likely to decrease, as described above. The examples shown in FIGS. 11 and 12 are particularly useful for maintaining the continuous gradation in a dark portion while ensuring that black output from a printer capable of performing printing on fabric has the maximum density because the color conversion in which the dark portion is adjusted is performed when the type of the medium 200, on which the print image IM0 is formed, is fabric.

### 5 Conclusions:

As described above, according to various aspects of the present disclosure, a configuration and the like capable of maintaining continuous gradation characteristics in a dark portion while ensuring that black color output from the output device has the maximum density can be provided. The basic effects and advantages described above can, of course, also be achieved by aspects having only configuration requirements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes the configurations described above and the like.

What is claimed is:

1. An image processing apparatus comprising:
a storage unit configured to store a correspondence between input coordinate values in an input color space that depends on an input device and output coordinate values in an output color space that depends on an output device; and
a processing unit configured to convert the input coordinate values into the output coordinate values in accordance with the correspondence,
wherein the processing unit is configured to
perform first adjustment on the correspondence, the first adjustment identifying darkest point output coordinate values that are the output coordinate values of a darkest point in the output color space and associating the darkest point output coordinate values with darkest point input coordinate values that are the input coordinate values of an input darkest point that is a point where brightness is lowest in the input color space, and
perform second adjustment on the correspondence, the second adjustment smoothing the output coordinate values corresponding to an adjustment point within an adjustment range around the input darkest point in the input color space based on the darkest point output coordinate values.

2. The image processing apparatus according to claim 1, further comprising
an acceptance unit configured to accept a setting of at least one of the darkest point input coordinate values and the darkest point output coordinate values.

3. The image processing apparatus according to claim 1, further comprising
an acceptance unit configured to accept a setting of the adjustment range,
wherein the processing unit is configured to perform the second adjustment within the set adjustment range.

4. The image processing apparatus according to claim 1, further comprising
an acceptance unit configured to accept a setting of a smoothing process of smoothing the output coordinate values corresponding to the adjustment point,
wherein the processing unit is configured to carry out the set smoothing process on the output coordinate values corresponding to the adjustment point in the second adjustment.

5. The image processing apparatus according to claim 1, wherein
the output device is a printer configured to form a print image by discharging ink onto a medium, an amount of the ink corresponding to the output coordinate values,
the image processing apparatus further comprises an acceptance unit configured to accept a setting of a type of the medium, on which the print image is formed, from multiple types including fabric and a second type different from the fabric,
when the fabric is set as the type of the medium, on which the print image is formed, the processing unit is configured to perform the first adjustment and the second adjustment on the correspondence, and convert the input coordinate values into the output coordinate values in accordance with the correspondence on which the first adjustment and the second adjustment are performed, and
when the second type is set as the type of the medium, on which the print image is formed, the processing unit is configured to convert the input coordinate values into the output coordinate values in accordance with the correspondence on which the first adjustment and the second adjustment is not performed.

6. A correspondence adjustment method for adjusting a correspondence used to convert input coordinate values in an input color space that depends on an input device into output coordinate values in an output color space that depends on an output device, the method comprising:
a first adjustment step of performing first adjustment on the correspondence, the first adjustment identifying darkest point output coordinate values that are the output coordinate values of a darkest point in the output color space and associating the darkest point output coordinate values with darkest point input coordinate values that are the input coordinate values of an input darkest point that is a point where brightness is lowest in the input color space, and
a second adjustment step of performing second adjustment on the correspondence, the second adjustment smoothing the output coordinate values corresponding to an adjustment point within an adjustment range around the input darkest point in the input color space based on the darkest point output coordinate values.
